(19) United States
(12) Patent Application Publication
(10) Pub. No.: US 2025/0089009 A1
(43) Pub. Date: Mar. 13, 2025

(54) SIDELINK POSITIONING METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Shichang ZHANG, Dongguan (CN); Teng MA, Dongguan (CN)

(21) Appl. No.: 18/956,884

(22) Filed: Nov. 22, 2024

Related U.S. Application Data
(63) Continuation of application No. PCT/CN2022/111758, filed on Aug. 11, 2022.

(51) Int. Cl. H04W 64/00; H04W 72/044

(52) U.S. Cl. CPC H04W 64/00; H04W 72/044

(57) ABSTRACT

Provided are a sidelink positioning method, a terminal device, and a network device. The method includes: determining, by a terminal device, a configuration parameter of a first sidelink positioning reference signal SL PRS, where the first SL PRS occupies a part or all of an SL PRS resource, and the configuration parameter is used to indicate one or more of the following information: a frequency domain resource, used for transmitting the first SL PRS, in the SL PRS resource; or an SL PRS sequence of the first SL PRS.

### CROSS-REFERENCE TO RELATED APPLICATIONS

This application is a continuation of International Application No. PCT/CN2022/111758, filed on Aug. 11, 2022, the disclosure of which is hereby incorporated by reference in its entirety.

### TECHNICAL FIELD

This application relates to the field of communication technologies, and more specifically, to a sidelink positioning method, a terminal device, and a network device.

### BACKGROUND

Currently, it is expected to enhance a positioning technology by introducing sidelink-based positioning. However, how the terminal device obtains a configuration parameter of a sidelink positioning reference signal (SL PRS) is a pressing problem to be solved.

### SUMMARY

This application provides a sidelink positioning method, a terminal device, and a network device. The following describes various aspects related to this application.

According to a first aspect, a sidelink positioning method is provided, including: determining, by a terminal device, a configuration parameter of a first sidelink positioning reference signal SL PRS, where the first SL PRS occupies a part or all of an SL PRS resource, and the configuration parameter is used to indicate one or more of the following information: a frequency domain resource, used for transmitting the first SL PRS, in the SL PRS resource; or an SL PRS sequence of the first SL PRS.

According to a second aspect, a sidelink positioning method is provided, including: sending, by a network device, a configuration parameter of a first sidelink positioning reference signal SL PRS to a terminal device, where the first SL PRS occupies a part or all of an SL PRS resource, and the configuration parameter is used to indicate one or more of the following information: a frequency domain resource, used for transmitting the first SL PRS, in the SL PRS resource; or an SL PRS sequence of the first SL PRS.

According to a third aspect, a terminal device is provided, including: a processing unit, configured to determine a configuration parameter of a first sidelink positioning reference signal SL PRS, where the first SL PRS occupies a part or all of an SL PRS resource, and the configuration parameter is used to indicate one or more of the following information: a frequency domain resource, used for transmitting the first SL PRS, in the SL PRS resource; or an SL PRS sequence of the first SL PRS.

According to a fourth aspect, a network device is provided, including: a sending unit, configured to send a configuration parameter of a first sidelink positioning reference signal SL PRS to a terminal device, where the first SL PRS occupies a part or all of an SL PRS resource; where the configuration parameter is used to indicate one or more of the following information: a frequency domain resource, used for transmitting the first SL PRS, in the SL PRS resource; or an SL PRS sequence of the first SL PRS.

According to a fifth aspect, a terminal device is provided, including a processor, a memory, and a communication interface, where the memory is configured to store one or more computer programs; and the processor is configured to invoke the computer program in the memory, to cause the terminal device to perform some or all of the steps of the method in the first aspect.

According to a sixth aspect, a network device is provided, and includes a processor, a memory, and a transceiver. The memory is configured to store one or more computer programs. The processor is configured to invoke the computer program in the memory to cause the network device to perform some or all of the steps in the method according to the second aspect.

According to a seventh aspect, an embodiment of this application provides a communication system. The system includes the foregoing terminal device and/or network device. In another possible design, the system may further include another device that interacts with the terminal device or the network device in the solutions provided in embodiments of this application.

According to an eighth aspect, an embodiment of this application provides a computer-readable storage medium. The computer-readable storage medium stores a computer program, and the computer program causes a communication device (for example, a terminal device or a network device) to perform some or all of the steps in the method according to the foregoing aspects.

According to a ninth aspect, an embodiment of this application provides a computer program product. The computer program product includes a non-transitory computer-readable storage medium that stores a computer program. The computer program is operable to cause a communication device (for example, a terminal device or a network device) to perform some or all of the steps in the method according to the foregoing aspects. In some implementations, the computer program product may be a software installation package.

According to a tenth aspect, an embodiment of this application provides a chip. The chip includes a memory and a processor, and the processor may invoke and run a computer program from the memory, to implement some or all of the steps in the method according to the foregoing aspects.

### BRIEF DESCRIPTION OF DRAWINGS

FIG. 1 is an example diagram of a system architecture of a wireless communication system to which embodiments of this application are applicable.

FIG. 2 is an example diagram of a scenario of sidelink communication within network coverage.

FIG. 3 is an example diagram of a scenario of sidelink communication with partial network coverage.

FIG. 4 is an example diagram of a scenario of sidelink communication out of network coverage.

FIG. 5 is an example diagram of a scenario of sidelink communication based on a central control node.

FIG. 6 is an example diagram of a broadcast-based sidelink communication manner.

FIG. 7 is an example diagram of a unicast-based sidelink communication manner.

FIG. 8 is an example diagram of a multicast-based sidelink communication manner.

FIG. 9 is a schematic diagram showing a resource for transmitting a DL PRS.

FIG. 10 is a schematic diagram of an SL PRS resource according to an embodiment of this application.

FIG. 11 is a schematic diagram of an SL PRS resource according to another embodiment of this application.

FIG. 12 is a schematic flowchart of a sidelink positioning method according to an embodiment of this application.

FIG. 13 is a schematic diagram of resources used for transmitting an SL PRS and a PSSCH DMRS in an SL PRS resource according to an embodiment of this application.

FIG. 14 is a schematic diagram of resources used for transmitting an SL PRS and a PSSCH DMRS in an SL PRS resource according to another embodiment of this application.

FIG. 15 is a schematic diagram of a terminal device according to an embodiment of this application.

FIG. 16 is a schematic diagram of a network device according to an embodiment of this application.

FIG. 17 is a schematic diagram of a structure of a communication apparatus according to an embodiment of this application.

### DESCRIPTION OF EMBODIMENTS

The technical solutions in this application are described below with reference to the accompanying drawings.

### Communication System Architecture

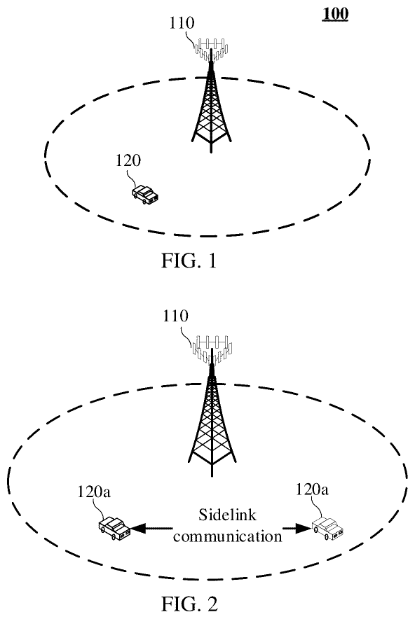

FIG. 1 is an example diagram of a system architecture of a wireless communication system 100 to which an embodiment of this application is applicable. The wireless communication system 100 may include a network device 110 and a terminal device 120. The network device 110 may be a device that communicates with the terminal device 120. The network device 110 may provide communication coverage for a specific geographic area, and may communicate with the terminal device 120 located within the coverage.

FIG. 1 shows one network device and one terminal device as an example. Optionally, the wireless communication system 100 may include one or more network devices 110, and/or one or more terminal devices 120. For a network device 110, the one or more terminal devices 120 may be located within network coverage of the network device 110, or may be located outside network coverage of the network device 110, or may be located partially within the network coverage of the network device 110, and may be located partially outside the network coverage of the network device 110, which is not limited in embodiments of this application.

Optionally, the wireless communication system 100 may further include another network entity such as a network controller or a mobility management entity. This is not limited in embodiments of this application.

It should be understood that the technical solutions of embodiments of this application may be applied to various communication systems, such as a 5^{th} generation (5G) system or new radio (NR), a long term evolution (LTE) system, an LTE frequency division duplex (FDD) system, and LTE time division duplex (TDD). The technical solutions provided in this application may be further applied to a future communication system, such as a 6^{th} generation mobile communication system or a satellite communication system.

The terminal device in embodiments of this application may also be referred to as user equipment (UE), an access terminal, a subscriber unit, a subscriber station, a mobile site, a mobile station (MS), a mobile terminal (MT), a remote station, a remote terminal device, a mobile device, a user terminal, a wireless communication device, a user agent, or a user apparatus. The terminal device in embodiments of this application may be a device providing a user with voice and/or data connectivity and capable of connecting people, objects, and machines, such as a handheld device or an in-vehicle device having a wireless connection function. The terminal device in embodiments of this application may be a mobile phone, a tablet computer (Pad), a notebook computer, a palmtop computer, a mobile internet device (MID), a wearable device, a vehicle, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. For example, the terminal device may act as a scheduling entity that provides a sidelink signal between terminal devices in vehicle-to-everything (V2X), device-to-device (D2D) communications, or the like. For example, a cellular phone and a vehicle communicate with each other through a sidelink signal. A cellular phone and a smart household device communicate with each other, without the relay of a communication signal through a base station. Optionally, the terminal device may function as a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master eNodeB (MeNB), a secondary eNodeB (SeNB), a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communication module, a modem, or a chip disposed in the device or the apparatus described above. Alternatively, the base station may be a mobile switching center, a device that assumes the function of a base station in device-to-device (D2D), V2X, and machine-to-machine (M2M) communications, a network-side device in a 6G network, a device that assumes the function of a base station in a future communication system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device that communicates with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

### Sidelink Communication in Different Network Coverage Statuses

Sidelink communication means a sidelink-based communication technology. The sidelink communication may be, for example, device to device (D2D) or vehicle to everything (V2X) communication. Communication data in a conventional cellular system is received or sent between a terminal device and a network device, while sidelink communication supports direct communication data transmission between terminal devices. Compared with conventional cellular communication, direct transmission of communication data between terminal devices may have higher spectral efficiency and a lower transmission delay. For example, an Internet of vehicles system uses a sidelink communication technology.

Sidelink communication may be classified, depending on a network coverage status of the terminal device, into sidelink communication within network coverage, sidelink communication with partial network coverage, and sidelink communication out of network coverage.

FIG. 2 is an example diagram of a scenario of sidelink communication within network coverage. In the scenario shown in FIG. 2, two terminal devices 120a are both located within coverage of a network device 110. Therefore, both the two terminal devices 120a may receive configuration signalling (where the configuration signalling in this application may alternatively be replaced with configuration information) from the network device 110, and determine a sidelink configuration based on the configuration signalling from the network device 110. After performing sidelink configuration, both the two terminal devices 120a may perform sidelink communication on a sidelink.

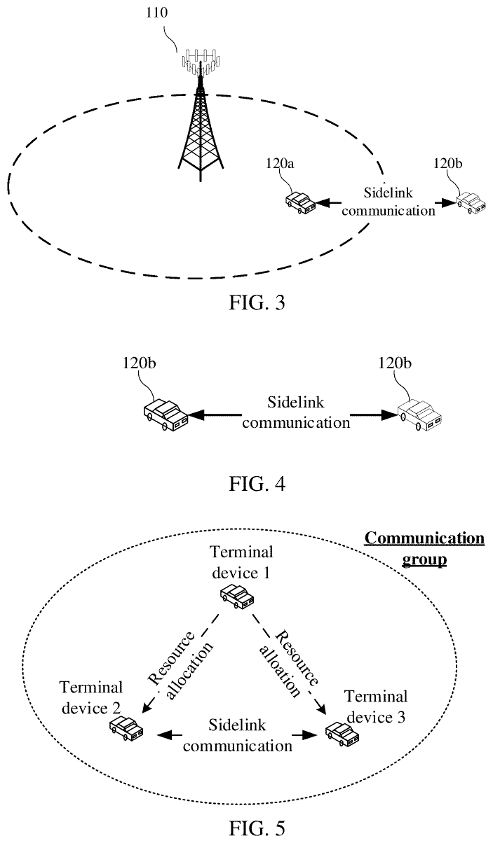

FIG. 3 is an example diagram of a scenario of sidelink communication with partial network coverage. In the scenario shown in FIG. 3, a terminal device 120a performs sidelink communication with a terminal device 120b. The terminal device 120a is located within coverage of a network device 110. Therefore, the terminal device 120a can receive configuration signalling from the network device 110, and determine a sidelink configuration based on the configuration signalling from the network device 110. The terminal device 120b is located out of network coverage, and cannot receive the configuration signalling from the network device 110. In this case, the terminal device 120b may determine a sidelink configuration based on preconfiguration information and/or information that is carried on a physical sidelink broadcast channel (PSBCH) and that is sent by the terminal device 120a located within the network coverage. After performing sidelink configuration, both the terminal device 120a and the terminal device 120b may perform sidelink communication on a sidelink.

FIG. 4 is an example diagram of a scenario of sidelink communication out of network coverage. In the scenario shown in FIG. 4, two terminal devices 120b are both located out of network coverage. In this case, both the two terminal devices 120b may determine a sidelink configuration based on preconfiguration information. After performing sidelink configuration, both the two terminal devices 120b may perform sidelink communication on a sidelink.

### Sidelink Communication Based on a Central Control Node

FIG. 5 is an example diagram of a scenario of sidelink communication based on a central control node. In the scenario of sidelink communication, a plurality of terminal devices may form a communication group, and the communication group has a central control node. The central control node may be a terminal device (for example, a terminal device 1 in FIG. 5) in the communication group, and the terminal device may also be referred to as a cluster header (CH) terminal device. The central control node may be responsible for implementing one or more of the following functions: establishing a communication group, adding a group member to or deleting a group member from a communication group, coordinating resources within a communication group, allocating sidelink transmission resources to another terminal device, receiving sidelink feedback information from another terminal device, and coordinating resources with another communication group.

### Mode of Sidelink Communication

Two modes of sidelink communication are defined in some standards or protocols (for example, the 3rd Generation Partnership Project (3GPP)): a first mode and a second mode.

In the first mode, a resource (the resource mentioned in this application may also be referred to as a transmission resource, such as a time-frequency resource) of a terminal device is allocated by a network device. The terminal device may send data on a sidelink based on the resource allocated by the network device. The network device may allocate a resource for a single time of transmission to the terminal device, or may allocate a resource for semi-static transmission to the terminal device. The first mode may be applied to a scenario in which there is coverage of the network device, for example, the scenario shown in FIG. 2 above. In the scenario shown in FIG. 2, the terminal device 120a is located within the network coverage of the network device 110. Therefore, the network device 110 may allocate, to the terminal device 120a, a resource used in a sidelink transmission process.

In the second mode, the terminal device may autonomously select one or more resources from a resource pool (RP). Then, the terminal device may perform sidelink transmission based on the selected resource. For example, in the scenario shown in FIG. 4, the terminal device 120b is located out of the cell coverage. Therefore, the terminal device 120b may autonomously select a resource from a preconfigured resource pool to perform sidelink transmission. Alternatively, in the scenario shown in FIG. 2, the terminal device 120a may autonomously select one or more resources from a resource pool configured by the network device 110 to perform sidelink transmission.

In some implementations, the terminal device may implement a resource allocation scheme in the second mode by using the following step 1 and step 2.

Step 1: The terminal device uses all available resources in a resource selection window as resource set A. Specifically, two cases may be included: Case 1-1 and Case 1-2.

In Case 1-1, if the terminal device does not monitor specific slots in a monitoring window, all resources of slots in the selection window that correspond to these slots not monitored are excluded. In some implementations, the terminal device may determine, based on a value set of a resource reservation period field in a used resource pool configuration, the slots in the selection window that correspond to the slots not monitored in the monitoring window.

In Case 1-2, if the terminal device detects a physical sidelink control channel (PSCCH) within a monitoring window, the terminal device measures a reference signal received power (RSRP) of the PSCCH or an RSRP of a PSSCH scheduled by the PSCCH. If the measured RSRP is greater than a sidelink reference signal received power (SL-RSRP) threshold, and it is determined, based on resource reservation information in sidelink control information transmitted in the PSCCH, that a resource reserved by the PSCCH is within the resource selection window, the corresponding resource is excluded from set A. If remaining resources in resource set A are less than X % of all resources in resource set A before resource exclusion, the SL-RSRP threshold is raised by 3 dB and step 1 is performed again. In some implementations, possible values of X may be {20, 35, 50}, and the terminal device may determine the parameter X from the value set based on a priority of to-be-sent data. In addition, the SL-RSRP threshold is related to a priority carried in the PSCCH detected by the terminal device and the priority of the to-be-sent data of the terminal device. The terminal device uses the remaining resources in set A after resource exclusion as a candidate resource set.

Step 2: The terminal device randomly selects several resources from the candidate resource set as transmitting resources for its initial transmission and re-transmission.

### Data Transmission Modes of Sidelink Communication

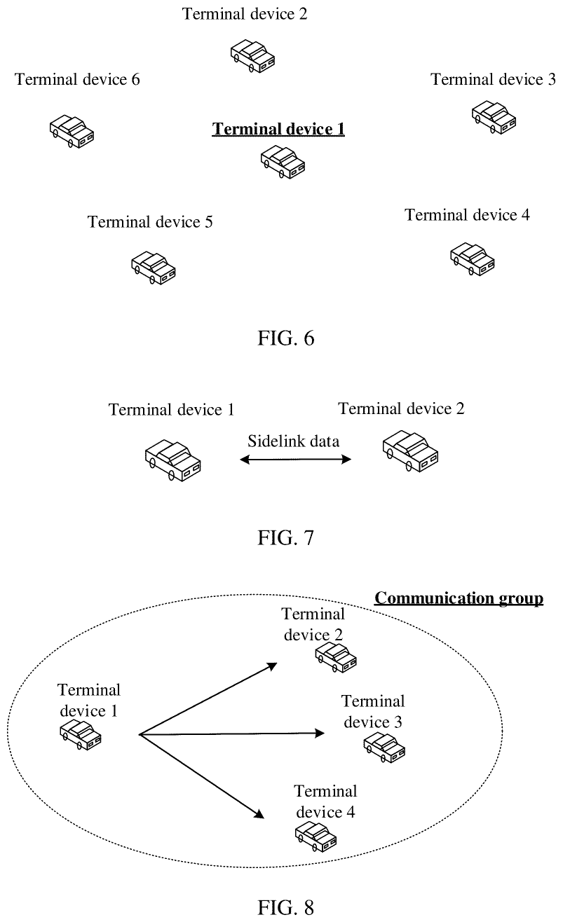

Some sidelink communication systems (such as long term evolution vehicle to everything (LTE-V2X)) support a broadcast-based data transmission mode (briefly referred to as broadcast transmission below). For the broadcast transmission, a receive-end terminal may be any terminal device around a transmit-end terminal. For example, in FIG. 6, a terminal device 1 is a transmit-end terminal, and a receive-end terminal corresponding to the transmit-end terminal is any terminal device around the terminal device 1, for example, may be a terminal device 2 to a terminal device 6 in FIG. 6.

In addition to the broadcast transmission, some communication systems also support a unicast-based data transmission mode (briefly referred to as unicast transmission below) and/or a multicast-based data transmission mode (briefly referred to as multicast transmission below). For example, new radio vehicle to everything (NR-V2X) expects to support autonomous driving. Autonomous driving poses higher requirements for data interaction between vehicles. For example, data interaction between vehicles requires a higher throughput, a lower delay, higher reliability, larger coverage, a more flexible resource allocation manner, and the like. Therefore, to improve performance of data interaction between vehicles, NR-V2X introduces unicast transmission and multicast transmission.

For the unicast transmission, the receive-end terminal usually has only one terminal device. For example, in FIG. 7, unicast transmission is performed between a terminal device 1 and a terminal device 2. The terminal device 1 may be a transmit-end terminal, and the terminal device 2 may be a receive-end terminal. Alternatively, the terminal device 1 may be a receive-end terminal, and the terminal device 2 may be a transmit-end terminal.

For the multicast transmission, the receive-end terminal may be terminal devices in a communication group, or the receive-end terminal may be terminal devices within a specific transmission distance. For example, in FIG. 8, a terminal device 1, a terminal device 2, a terminal device 3, and a terminal device 4 form a communication group. If the terminal device 1 sends data, all the other terminal devices (the terminal device 2 to the terminal device 4) in the group may be receive-end terminals.

### Downlink-Based Positioning

In downlink-based positioning, a network device may provide a downlink positioning reference signal (DL PRS) configuration of four positioning frequency layers for a terminal device. The following DL PRS configuration parameters are provided in a parameter structure of each positioning frequency layer: a subcarrier spacing of a DL PRS; a cyclic prefix (CP) length of a DL PRS; a frequency domain resource bandwidth of a DL PRS; a frequency domain start frequency position of a DL PRS resource; a frequency domain reference point “Point A” of a DL PRS; and a comb size “Comb-N” of a DL PRS.

A value of the frequency domain resource bandwidth of the DL PRS may be a quantity of physical resource blocks (PRBs) allocated to the DL PRS. In some cases, a minimum value of the frequency domain resource bandwidth of the DL PRS may be 24 PRBs, with a granularity of 4 PRBs. A maximum value of the frequency domain resource bandwidth of the DL PRS may be 272 PRBs.

The frequency domain start frequency position of the DL PRS resource is used to indicate an index number of a start PRB of the DL PRS in frequency domain resource allocation. An index number of a PRB is defined relative to the frequency domain reference point “Point A” of the DL PRS relative to the DL PRS.

The foregoing DL PRS configuration parameters corresponding to each positioning frequency layer may be applied to all DL PRS resources included in the positioning frequency layer. That is, in a positioning frequency layer, all DL PRSs from a plurality of different TRPs can use a same subcarrier spacing and CP length and a same comb size, be sent on a same frequency subband, and occupy a same bandwidth. Such a design allows the terminal device to simultaneously receive and measure DL PRSs from a plurality of different TRPs on a same frequency.

In some scenarios, parameters of a TRP layer also include the DL PRS configuration parameters. The parameters of the TRP layer may include a parameter for uniquely identifying and locating a TRP, such as a physical cell ID of the TRP, an NR cell global identifier (NCGI) of the TRP, or an absolute radio frequency channel number (ARFCN) of the TRP. Usually, a maximum of two DL PRS resource sets may be configured in each TRP layer. For each DL PRS resource set, the DL PRS configuration parameters in the parameters of the TRP layer include: a DL PRS resource set identifier (represented by “nr-DL-PRS-ResourceSetID”); a transmission period and slot offset of a DL PRS (represented by “dl-PRS-Periodicity-and-ResourceSetSlotOffset”); a repetition factor of a DL PRS resource (represented by “dl-PRS-ResourceRepetitionFactor”); a time interval for re-transmission of a DL PRS resource (represented by “dl-PRS-ResourceTimeGap”); a DL PRS muting configuration; and a quantity of orthogonal frequency division multiplexing (OFDM) symbols (briefly referred to as “symbols” below) occupied by the DL PRS resource (represented by “dl-PRS-NumSymbols”).

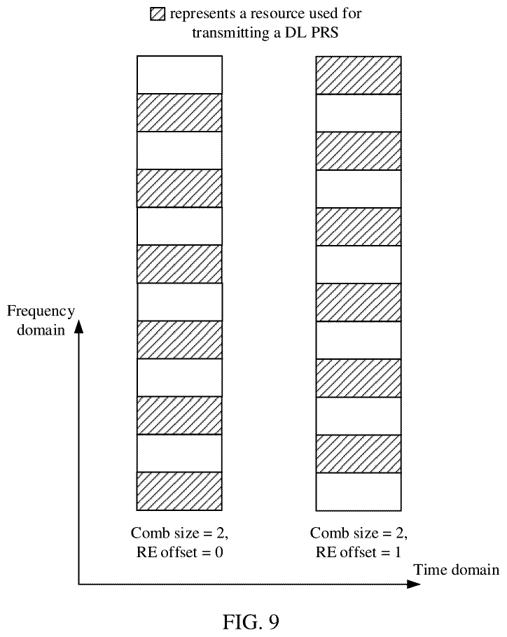

The transmission period and slot offset of a DL PRS are used to indicate time domain sending behavior of all DL PRS resources in the DL PRS resource set. In some implementations, a minimum value of a configurable DL PRS transmission period is 4 milliseconds, and a maximum value of a configurable DL PRS transmission period is 10240 milliseconds. Currently, configuration of a DL PRS supports flexible subcarrier spacings: including 15 KHz, 30 KHz, 60 KHz, and 120 KHz. In the case of different subcarrier spacings, the configurable DL PRS transmission period may have a same value range. FIG. 9 is a schematic diagram showing resources for transmitting a DL PRS in a case that the comb size is 2 and RE offsets are 0 and 1 respectively.

The repetition factor of the DL PRS resource is used to indicate a number of repetitions of a DL PRS resource in each DL PRS transmission period. Currently, repetitions of a same DL PRS resource may be used by the terminal device to aggregate DL PRS energy of a plurality of transmissions, which helps increase a coverage distance of a DL PRS and improve positioning precision. In an FR2 system, repetition of the DL PRS resource may also be used by the terminal device to perform receive beam sweeping operations. The terminal device may use different receive beams to receive repetitions of a same DL PRS resource, so as to find an optimal TRP transmit beam matching the receive beam of the terminal device. However, repetitions of the DL PRS resource increase DL PRS transmission overheads. Currently, in order to control the transmission overheads, the repetition factor of the DL PRS resource is set to 1, 2, 4, 6, 8, 16, or 32 in the 3GPP NR R16 specification.

The time interval for re-transmission of the DL PRS resource is used to indicate a quantity of slots between two consecutive repetitions of a same DL PRS resource.

The DL PRS muting configuration is used to indicate not to send a DL PRS on some allocated time-frequency resources. The muting configuration may be understood as follows: A DL PRS is not sent on all allocated time-frequency resources, and is intentionally not sent on some designated time-frequency resources. The muting configuration can avoid a conflict between a DL PRS and another signal (such as a synchronization signal block (SSB)). Further, the muting configuration can avoid interference between signals sent by different TRPs. For example, the muting configuration can be used to instruct a TRP that is closer to the terminal device not to send a DL PRS, and a TRP that is farther away from the terminal device is configured to send a DL PRS. In this way, the terminal device is not interfered by a TRP that is indicated to be muted, but receives a DL PRS from the farther TRP.

The quantity of OFDM symbols occupied by the DL PRS resource is used to indicate a quantity of OFDM symbols allocated to one DL PRS resource in one slot.

Usually, the DL PRS configuration parameters included in the parameters of the TRP layer may be applied to all DL PRS resources in a DL PRS resource set corresponding to the TRP layer. Therefore, on DL PRS resources belonging to a same DL PRS resource set, DL PRSs are sent in a same transmission period with a same number of repetitions, and the DL PRSs occupy a same quantity of OFDM symbols.

In some implementations, for each DL PRS resource, the DL PRS configuration parameters may further include: a DL PRS resource identifier ID (represented by “nr-DL-PRS-ResourceID”); a DL PRS sequence ID (represented by “dl-PRS-SequenceID”); a start frequency domain resource unit offset of a DL PRS (represented by “dl-PRS-CombSizeN-AndReOffset”); a DL PRS resource slot offset (represented by “dl-PRS-ResourceSlotOffset”); a DL PRS OFDM symbol offset (represented by “dl-PRS-ResourceSymbolOffset”); and DL PRS quasi co-location (QCL) information (represented by “dl-PRS-QCL-Info”).

The start frequency domain resource unit offset of a DL PRS is used to indicate a frequency domain resource unit offset value used for resource mapping on the 1^{st} allocated OFDM symbol of the DL PRS resource in one slot. Usually, based on this parameter and a relative offset value defined in TS38.211, the terminal device may determine a frequency domain resource unit offset value used for resource mapping on each OFDM symbol.

The DL PRS resource slot offset is used to indicate a slot offset relative to a DL PRS resource set. This parameter may determine a slot position in which each DL PRS resource is located.

The DL PRS OFDM symbol offset is used to indicate a time-frequency resource allocation position of a DL PRS resource in one slot. This parameter may be used to indicate an index number of a start OFDM symbol in a slot.

The DL PRS QCL information is used to indicate QCL information of a DL PRS.

### Sidelink-Based Positioning

The sidelink-based positioning is one of enhancement schemes of R18 positioning technologies. In this topic, scenarios and requirements supporting NR positioning use cases within, partially within, and outside coverage of a cellular network are considered. Positioning requirements of V2X use cases, public safety use cases, commercial use cases, and industrial internet of things (IIOT) use cases are considered. In addition, support for the following functions is considered: absolute positioning, ranging/direction measurement, and relative positioning; studying a positioning method combining sidelink measurement quantities and Uu interface measurement quantities; studying sidelink positioning reference signals, including signal design, physical layer control signaling, resource allocation, physical layer measurement quantities, and related physical layer processes; and studying positioning system architectures and signalling processes, such as configuration and measurement reporting.

For absolute positioning, the terminal device may directly determine, based on a measurement result, an absolute geographic location of the terminal device, or referred to as terminal device-based absolute positioning. Alternatively, the terminal device may report the measurement result to a positioning server, such as LMF, and then the LMF calculates the absolute location of the terminal device and notifies the terminal device of the absolute location. Such a manner is referred to as terminal device-assisted absolute positioning. For ranging/direction measurement or relative positioning, the terminal device may estimate information such as a signal round-trip time, an arrival angle, and signal reception strength based on a received positioning reference signal, and estimate a relative distance and a relative direction.

As described above, it is currently expected to enhance a positioning technology by introducing sidelink-based positioning. For ease of understanding of this application, a time domain location of an SL PRS resource in a sidelink communication system in embodiments of this application is first described below.

It is assumed that a time domain unit set may include one or more time domain units, and in some implementations, all time domain units in the time domain unit set may be used for transmitting an SL PRS, that is, the time domain unit included in the time domain unit set is an SL PRS resource. In some other implementations, a part of time domain units in the time domain unit set may be used for transmitting an SL PRS.

In some implementations, a time domain unit used for transmitting an SL PRS in the time domain unit set may be divided into one or more SL PRS resources. The SL PRS resource may be reserved or selected as a whole by a terminal device, or in other words, the SL PRS resource may be a basic time domain unit for resource reservation by the terminal device.

In this embodiment of this application, if the time domain unit used for transmitting an SL PRS in the time domain unit set may be divided into a plurality of SL PRS resources, it facilitate s improving flexibility of the SL PRS resource. If the time domain unit used for transmitting an SL PRS in the time domain unit set may be divided into one SL PRS resource, it facilitates simplifying complexity of reserving or selecting an SL PRS resource.

In some implementations, one or more time domain units included in one SL PRS resource may belong to one resource pool (such as an SL PRS resource pool). In some other implementations, a quantity of time domain units of an SL PRS resource included in one time domain unit set is less than or equal to a quantity of time domain units, belonging to a sidelink resource pool, in the time domain unit set.

In some implementations, the SL PRS resource may also be used for transmitting a PSSCH demodulation reference signal (DMRS). In this case, the PSSCH DMRS may be referred to as a second-type SL PRS. Accordingly, the SL PRS may be referred to as a first-type SL PRS. Certainly, in this embodiment of this application, the SL PRS resource may also be used only for transmitting the first-type SL PRS.

For example, the time domain unit set is slot, and the time domain unit is symbol. The SL PRS resource may be formed by one or more symbols belonging to an SL PRS resource pool, symbols belonging to a same SL PRS resource may be located in a same slot, and a quantity of symbols of the SL PRS resource is less than or equal to a quantity of symbols belonging to an SL PRS resource pool in one slot.

The time domain unit set may be any time domain unit set in a known communication system, for example, a slot, a subframe, or a frame. Certainly, the time domain unit set may alternatively be any time domain unit set introduced in a future communication system, which is not limited in embodiments of this application.

In addition, the time domain unit may be any time domain unit in a known communication system, for example, a symbol, a slot, a subframe, or a frame. Certainly, the time domain unit may alternatively be any time domain unit introduced in a future communication system, which is not limited in embodiments of this application.

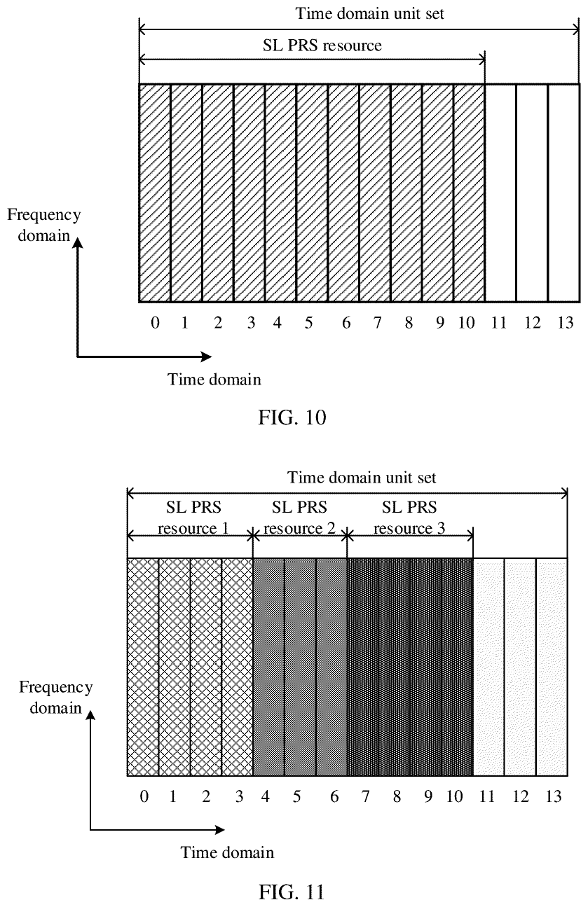

The SL PRS resource in embodiments of this application is described with reference to FIG. 10 and FIG. 11 by using an example in which a part of time domain units in a time domain unit set are used for transmitting an SL PRS.

In some implementations, a time domain unit used for transmitting an SL PRS in a time domain unit set may be considered as one SL PRS resource. Refer to FIG. 10. It is assumed that the time domain unit set includes 14 time domain units: time domain units 0 to 13, time domain units 0 to 10 are used for transmitting an SL PRS, and time domain units 11 to 13 are used for sidelink communication, for example, transmitting a PSCCH, a PSSCH, or a PSFCH. In this case, time domain units 0 to 10 may be considered as one SL PRS resource.

In some implementations, time domain units in the time domain unit set that are used for transmitting an SL PRS may be considered as a plurality of SL PRS resources. Refer to FIG. 11. It is assumed that the time domain unit set includes 14 time domain units: time domain units 0 to 13, time domain units 0 to 10 are used for transmitting an SL PRS, and time domain units 11 to 13 are used for sidelink communication, for example, transmitting a PSCCH, a PSSCH, or a PSFCH. In this case, time domain units 0 to 3 may be considered as one SL PRS resource, namely, SL PRS resource 1. Time domain units 4 to 6 may be considered as one SL PRS resource, namely, SL PRS resource 2. Time domain units 7 to 10 may be considered as one SL PRS resource, namely, SL PRS resource 3.

As described above, in a downlink positioning scenario, the DL PRS configuration parameters are configured by the network device (for example, an access network device and a core network device). If the sidelink-based positioning solution is introduced, how the terminal device obtains a configuration parameter of a PRS (also referred to as “first SL PRS”) transmitted on a sidelink becomes a pressing problem to be solved.

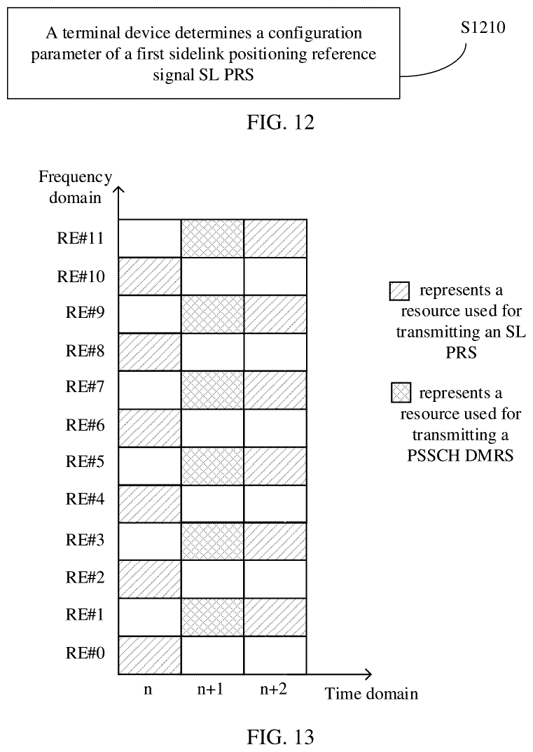

Therefore, to solve the foregoing problem, an embodiment of this application provides a sidelink positioning method. In embodiments of this application, a terminal device can determine a configuration parameter of a first SL PRS, so that the terminal device can transmit the first SL PRS to another terminal device based on the configuration parameter, which is beneficial to achieve sidelink-based positioning. For ease of understanding, the following describes a flowchart of a sidelink positioning method in an embodiment of this application with reference to FIG. 12. The method shown in FIG. 12 may include step S1210.

Step S1210: A terminal device determines a configuration parameter of a first sidelink positioning reference signal SL PRS.

The first SL PRS may occupy a part or all of an SL PRS resource, or in other words, the first SL PRS may occupy a part or all of time domain units in the SL PRS resource. For the description of the SL PRS resource, refer to the description above. For brevity, details are not described herein again.

In some implementations, the applicable scope of the foregoing configuration parameter may be one or more of an SL BWP or an SL PRS resource pool that can be used for SL PRS sending, or an SL frequency layer that can be used for an SL PRS.

That is, if the configuration parameter is configured for the SL BWP, SL PRSs sent in all resource pools that can be used for SL PRS sending within the SL BWP range can use the foregoing configuration parameter. If the configuration parameter is configured for the SL frequency layer, SL PRSs sent in all resource pools that can be used for SL PRS sending within the SL frequency layer range can use the foregoing configuration parameter. If the configuration parameter is configured for the SL PRS resource pool, SL PRSs sent in all resource pools that can be used for SL PRS sending in the SL PRS resource pool can use the foregoing configuration parameter. The following mainly uses the configuration parameter for the SL PRS resource pool as an example.

In this embodiment of this application, there are a plurality of manners of determining the foregoing configuration parameter. In some implementations, the foregoing configuration parameter may be configured by a network device for the terminal device. The network device may include an access network device and/or a core network device (such as an LMF) For example, the network device may configure the foregoing configuration parameter for the SL PRS resource pool. For another example, the network device may configure the foregoing configuration parameter for an SL BWP that can be used for SL PRS sending. For another example, the network device may configure the foregoing configuration parameter for an SL frequency layer that can be used for an SL PRS.

In some other implementations, the foregoing configuration parameter may be preconfigured. For example, the foregoing configuration parameter may be preconfigured for the SL PRS resource pool. For another example, the foregoing configuration parameter may be preconfigured for an SL BWP that can be used for SL PRS sending. For another example, the foregoing configuration parameter may be preconfigured for an SL frequency layer that can be used for an SL PRS. This is not limited in embodiments of this application.

In some other implementations, the foregoing configuration parameter may be autonomously selected by the terminal device. The determining manners are described subsequently in details. For brevity, details are not described herein again.

In some implementations, the configuration parameter of the first SL PRS may include one or more of the following configuration parameters: a subcarrier spacing of the first SL PRS; a CP length of the first SL PRS; a frequency domain resource bandwidth of the first SL PRS; a frequency domain start frequency position of resource of a first SL PRS resource; a frequency domain reference point of the first SL PRS; or a comb size of the first SL PRS; a resource set identifier of the first SL PRS; a transmission period and a slot offset of the first SL PRS; a repetition factor of a first SL PRS resource; a time interval for re-transmission of the first SL PRS resource; a muting configuration of the first SL PRS; a quantity of symbols occupied by resources of the first SL PRS; a resource identifier ID of the first SL PRS; a sequence indication information (for example, a sequence identifier) of the first SL PRS; a start frequency domain resource unit offset of the first SL PRS; a resource slot offset of the first SL PRS; an OFDM symbol offset of the first SL PRS; or quasi-co-location information of the first SL PRS.

In some implementations, the configuration parameter of the first SL PRS may be used to configure transmission of the first SL PRS. For example, the configuration parameter may be used to indicate a time domain resource of the first SL PRS in the SL PRS resource, a frequency domain resource of the first SL PRS in the SL PRS resource, a signal sequence of the first SL PRS in the SL PRS resource, and a transmission parameter of the first SL PRS in the SL PRS resource (for example, a transmission period of the first SL PRS or a time interval for re-transmission).

In some implementations, if the configuration parameter of the first SL PRS indicates the frequency domain resource of the first SL PRS in the SL PRS resource, the configuration parameter may include a first frequency domain offset value corresponding to a resource used for transmitting an SL PRS on a reference time domain unit of the SL PRS resource; and/or a comb size corresponding to the first SL PRS transmitted in the SL PRS resource.

The reference time domain unit may be an earliest time domain unit in time domain units included in the SL PRS resource, or in other words, the reference time domain unit may be a time domain unit with an earliest time domain position in the SL PRS resource. Still refer to FIG. 10. The reference time domain unit may be time domain unit 0 in the SL PRS resource. In this embodiment of this application, the reference time domain unit may alternatively be a time domain unit with a latest (or last) time domain position in the SL PRS resource. Certainly, in this embodiment of this application, the reference time domain unit may alternatively be any time domain unit in the SL PRS resource.

The first frequency domain offset value may be a resource element (RE) offset value. Certainly, the first frequency domain offset value may alternatively be an offset value represented by another frequency domain unit, which is not limited in embodiments of this application.

In some implementations, a frequency domain offset value for transmitting the first SL PRS on another time domain unit (also referred to as “first time domain unit”) different from the reference time domain unit in the SL PRS resource may be determined based on the first frequency domain offset value.

In some implementations, the frequency domain offset value for transmitting the first SL PRS on the first time domain unit may be determined based on the first frequency domain offset value, a time interval between the first time domain unit and the reference time domain unit, and a comb size of the first SL PRS.

That the reference time domain unit is an earliest time domain unit in the SL PRS resource is used as an example. Assuming that the first frequency domain offset value in the SL PRS resource is k_{offset}^{PRS} and the comb size of the first SL PRS in the SL PRS resource is K_{comb}^{PRS}, a frequency domain offset value k corresponding to the first time domain unit may be determined based on the formula k=(k_{offset}^{PRS}+k′) mod K_{comb}^{PRS}, where k′ may be determined based on a time interval D between the first time domain unit and the reference time domain unit and Table 1, D=l−lₛₜₐᵣₜ^{PRS}, l represents an index of the first time domain unit in the SL PRS resource, and lₛₜₐᵣₜ^{PRS} represents an index of the reference time domain unit in the SL PRS resource.

TABLE 1

| | D | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

As described above, in some scenarios, the SL PRS resource includes a time domain unit used for transmitting a PSSCH DMRS. In some implementations, a frequency domain offset value corresponding to the time domain unit used for transmitting a PSSCH DMRS may be a preset value, for example, may be 0. The following describes manners of calculating the frequency domain offset value corresponding to the first time domain unit in the foregoing scenario with reference to Manner 1 and Manner 2.

In Manner 1, the frequency domain offset value corresponding to the first time domain unit may be determined based on the first frequency domain offset value and a first parameter. The first parameter is used to indicate a quantity of time domain units between the reference time domain unit and the first time domain unit in the SL PRS resource, and/or a quantity of time domain units used for transmitting a PSSCH DMRS in the SL PRS resource.

In some implementations, the frequency domain offset value corresponding to the first time domain unit may be determined based on the first frequency domain offset value, the first parameter, a time interval between the first time domain unit and the reference time domain unit, and a comb size of the first SL PRS.

That the reference time domain unit is an earliest time domain unit in the SL PRS resource is used as an example. Assuming that the first frequency domain offset value in the SL PRS resource is k_{offset}^{PRS} and the comb size of the first SL PRS in the SL PRS resource is K_{comb}^{PRS}, a frequency domain offset value k corresponding to the first time domain unit may be determined based on the formula k=(k_{offset}^{PRS}+k′) mod K_{comb}^{PRS}, where k′ may be determined based on a time interval D between the first time domain unit and the reference time domain unit and Table 1, D=l−lₛₜₐᵣₜ^{PRS}−Δ, l represents an index of the first time domain unit in the SL PRS resource, lₛₜₐᵣₜ^{PRS} represents an index of the reference time domain unit in the SL PRS resource, and Δ represents the first parameter, that is, the quantity of time domain units that are used for transmitting a PSSCH DMRS and that is between the reference time domain unit and the first time domain unit in the SL PRS resource.

FIG. 13 is a schematic diagram of resources used for transmitting an SL PRS and a PSSCH DMRS in an SL PRS resource according to an embodiment of this application. It is assumed that the SL PRS resource includes time domain unit n, time domain unit n+1, and time domain unit n+2, time domain unit n is the reference time domain unit, the first frequency domain offset k_{offset}^{PRS} corresponding to the reference time domain unit is 0, the comb size K_{comb}^{PRS} of the first SL PRS is 2, and the first parameter Δ is 1. Correspondingly, based on the foregoing formula, it may be calculated that a frequency domain offset value corresponding to time domain unit n+2 is 1. In this case, resource distribution of an SL PRS resource for transmitting an SL PRS and a PSSCH DMRS may be shown in FIG. 13.

In Manner 2, the frequency domain offset value corresponding to the first time domain unit may be determined based on the first frequency domain offset value and a second parameter.

The second parameter is used to indicate a quantity of time domain units used for transmitting a PSSCH DMRS between the earliest time domain unit in the SL PRS resource and the first time domain unit and a quantity of second time domain units.

In some implementations, the second time domain unit is a 1^{st} time domain unit following a time domain unit for transmitting a PSSCH DMRS (also referred to as a PSSCH DMRS time domain unit) in the SL PRS resource. In other words, the second time domain unit is a 1^{st} time domain unit that is used for transmitting an SL PRS and that follows a time domain unit used for transmitting a PSSCH DMRS in the SL PRS resource.

In some implementations, a frequency domain offset value corresponding to a frequency domain resource used for transmitting the first SL PRS in the second time domain unit may be set to be different from a frequency domain offset value corresponding to a resource used for transmitting the PSSCH DMRS in the SL PRS resource. This beneficial to stagger the frequency domain resource for transmitting the first SL PRS in the second time domain unit and a frequency domain resource for transmitting the PSSCH DMRS in a PSSCH DMRS time domain unit. For example, the frequency domain offset value corresponding to the resource used for transmitting the PSSCH DMRS in the SL PRS resource is 0, and the frequency domain offset value corresponding to the second time domain unit is 1.

Certainly, in this embodiment of this application, the frequency domain offset value corresponding to the second time domain unit may be the same as the frequency domain offset value corresponding to the PSSCH DMRS time domain unit, which is not limited in embodiments of this application.

In some implementations, the frequency domain offset value corresponding to the first time domain unit may be determined based on the first frequency domain offset value, the second parameter, a time interval between the first time domain unit and the reference time domain unit, and a comb size of the first SL PRS.

That the reference time domain unit is an earliest time domain unit in the SL PRS resource is used as an example. Assuming that the first frequency domain offset value in the SL PRS resource is k_{offset}^{PRS} and the comb size of the first SL PRS in the SL PRS resource is K_{comb}^{PRS}, a frequency domain offset value k corresponding to the first time domain unit may be determined based on the formula k=(k_{offset}^{PRS}+k′) mod K_{comb}^{PRS}, k′ may be determined based on a time interval D between the first time domain unit and the reference time domain unit and Table 1, D=l−lₛₜₐᵣₜ^{PRS}−2*Δ, l represents an index of the first time domain unit in the SL PRS resource, and lₛₜₐᵣₜ^{PRS} represents an index of the reference time domain unit in the SL PRS resource, and 2*Δ represents the second parameter, that is, a sum of the quantity of second time domain units and the quantity of time domain units that are used for transmitting a PSSCH DMRS and that are between the reference time domain unit and the first time domain unit in the SL PRS resource.

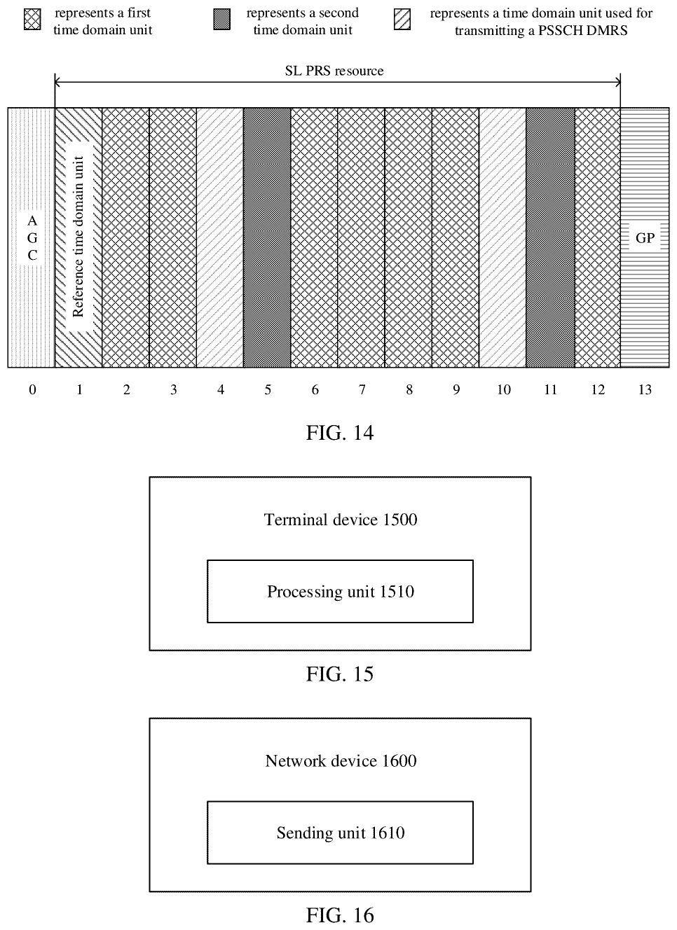

FIG. 14 is a schematic diagram of resources used for transmitting an SL PRS and a PSSCH DMRS in SL PRS resource according to another embodiment of this application. It is assumed that a time domain unit set includes time domain units 0 to 13, and time domain units 1 to 12 belong to an SL PRS resource, time domain unit 0 is used for AGC, and time domain unit 13 is used for a GP. In addition, time domain unit 1 is a reference time domain unit, time domain unit 4 and time domain unit 10 are time domain units used for transmitting a PSSCH DMRS, and time domain unit 5 that follows time domain unit 4 and time domain unit 11 that follows time domain unit 10 are second time domain units. Time domain units 2 and 3, time domain units 6 to 9, and time domain unit 12 are first time domain units.

Correspondingly, a frequency domain offset value corresponding to the first time domain unit may be determined according to the method described in the foregoing Manner 2. Herein, a parameter D corresponding to time domain unit 2 is 1, a parameter D corresponding to time domain unit 3 is 2, a parameter D corresponding to time domain unit 6 is 3, a parameter D corresponding to time domain unit 7 is 4, a parameter D corresponding to time domain unit 8 is 5, a parameter D corresponding to time domain unit 9 is 6, and a parameter D corresponding to time domain unit 12 is 7.

In some implementations, after the first frequency domain offset value k is calculated based on the foregoing manner, a frequency domain position k₁ for transmitting a first SL PRS is calculated based on the first frequency domain offset value k. The first frequency domain offset value k=(k_{offset}^{PRS}+k′) mod K_{comb}^{PRS} is used as an example. k=mK_{comb}^{PRS}+k=mK_{comb}^{PRS}+((k_{offset}^{PRS}+k′) mod K_{comb}^{PRS}), where m=0, 1, . . . . A value of k₁ is used to indicate a reference point of the frequency domain position.

In some implementations, k₁=0 may indicate that the reference point is an earliest frequency domain resource in frequency domain resources allocated to the terminal device, for example, the 1^{st} RE in the 1^{st} PRB allocated to the terminal device. In some other implementations, k₁=0 may indicate that the reference point is a start frequency domain resource in an SL PRS resource pool, for example, the 1^{st} RE of the 1^{st} PRB in the SL PRS resource pool. In some other implementations, k₁=0 may indicate that the reference point is a start frequency domain resource of a current SL BWP, for example, the 1^{st} RE of the 1^{st} PRB of the current SL BWP.

As described above, the first frequency domain offset value may be autonomously selected by the terminal device. In some implementations, the first frequency domain offset value may be determined based on a resource monitoring result of the terminal device for the SL PRS resource. For example, the terminal device may receive SL PRS resource reservation information sent by another terminal device, measure a receiving power (such as SL RSRP) of a signal sent by the another terminal, exclude a resource reserved by the terminal with high signal received power, and finally determine the first frequency domain offset value from remaining resources. Certainly, in this embodiment of this application, the terminal device may alternatively randomly determine the first frequency domain offset value, which is not limited in embodiments of this application.

It should be noted that if the terminal device can autonomously select an SL PRS sending resource from the SL PRS resource pool, the terminal device can autonomously determine the first frequency domain offset value used by the terminal device to send an SL PRS. Certainly, in this embodiment of this application, if the terminal device can autonomously select an SL PRS sending resource from the SL PRS resource pool, the first frequency domain offset value can alternatively be selected by the network device.

As described above, the first frequency domain offset value may be configured by the network device for the terminal device. In some implementations, the network device may determine the first frequency domain offset value based on a comb size of the first SL PRS. Certainly, in this embodiment of this application, the network device may alternatively determine the first frequency domain offset value in another manner, which is not limited in embodiments of this application.

The solutions in embodiments of this application are described above by using an example in which the configuration parameter includes the first frequency domain offset value. The following describes the solutions by using an example in which the configuration parameter includes the comb size of the first SL PRS.

In some implementations, the comb size is used to indicate a frequency domain spacing between two adjacent SL PRSs transmitted by the terminal device in the SL PRS resource.

It should be noted that the two adjacent SL PRSs described above may be understood as follows: Time domain resources occupied by the two SL PRSs are discontinuous, but the terminal device does not transmit another SL PRS between sending times of the two SL PRSs. Alternatively, the two adjacent SL PRSs may be understood as follows: Time domain resources occupied by the two SL PRSs are continuous and adjacent.

In some implementations, the frequency domain spacing is associated with a quantity of time domain units used for transmitting a PSSCH DMRS in the SL PRS resource. In other words, the frequency domain spacing is associated with whether the SL PRS resource includes a resource for transmitting a PSSCH DMRS.

For example, the SL PRS resource includes a resource used for transmitting a PSSCH DMRS; and a frequency domain spacing corresponding to an SL PRS in the SL PRS resource may be two frequency domain units, that is, the comb size may be 2. For another example, the SL PRS resource does not include a resource used for transmitting a PSSCH DMRS; a frequency domain spacing corresponding to an SL PRS in the SL PRS resource may be one frequency domain unit, that is, the comb size may be 1.

In some implementations, the comb size corresponding to the first SL PRS is less than or equal to a quantity of symbols used for sending an SL PRS in the SL PRS resource. For example, the comb size corresponding to the first SL PRS may be less than or equal to a quantity of symbols included in the SL PRS resource minus 1.

In some implementations, the configuration parameter belongs to a configuration parameter set, and the configuration parameter set includes a candidate value of one or more configuration parameters. In other words, the comb size corresponding to the first SL PRS may belong to a comb size set, and the comb size set includes one or more comb size candidate values. For example, the comb size set may be represented as {2, 4, 6, 12}, where four comb size candidate values included are 2, 4, 6, and 12, respectively.

It should be noted that the configuration parameter set may be configured by the network device or predefined by a protocol, which is not limited in embodiments of this application.

In some implementations, a candidate value in the configuration parameter set may be associated with a type of a resource pool in which the SL PRS resource is located. Types of resource pools may include a dedicated resource pool and a shared resource pool. The dedicated resource pool indicates that all resources in the resource pool are only used to send an SL PRS, or all resources in the resource pool are only used to send an SL PRS and a PSSCH DMRS. The shared resource pool indicates that all resources in the resource pool can be used to send sidelink signals such as an SL PRS, a PSSCH DMRS, a PSCCH, and a PSSCH.

In some implementations, if the resource pool is a dedicated resource pool, a comb size candidate value corresponding to the resource pool may include one or more comb sizes of the comb size set. If the resource pool is a shared resource pool, a comb size candidate value corresponding to the resource pool may be one comb size of the comb size set.

The comb size set is, for example, {2, 4, 6, 12}. If the resource pool is a dedicated resource pool, comb size candidate values corresponding to the resource pool may include one or more of 2, 4, 6, or 12. If the resource pool is a shared resource pool, a comb size candidate value corresponding to the resource pool may be 2.

Accordingly, the terminal device may autonomously determine the comb size corresponding to the first SL PRS from the foregoing comb size set, or the network device may select the comb size corresponding to the first SL PRS from the comb size set for the terminal device. This is not limited in embodiments of this application.

In some implementations, the comb size corresponding to the first SL PRS may be determined based on an expected comb size of the terminal device. That is, the terminal device may send the expected comb size to the network device, so that the network device configures, for the terminal device based on the expected comb size, the comb size corresponding to the first SL PRS.

In some implementations, the terminal device may determine the expected comb size based on a positioning requirement (for example, time required for positioning). Usually, if the positioning needs to be completed in a shorter time, a smaller comb size can be selected as the comb size expected by the terminal device. On the contrary, if the positioning can be completed in a longer time, a larger comb size can be selected as the comb size expected by the terminal device.

Certainly, in this embodiment of this application, the comb size corresponding to the first SL PRS may alternatively be directly selected according to a positioning requirement. Usually, if the positioning needs to be completed in a shorter time, a smaller comb size may be selected as the comb size corresponding to the first SL PRS. On the contrary, if the positioning can be completed in a longer time, a larger comb size can be selected as the comb size corresponding to the first SL PRS.

The manners of determining the first frequency domain offset value and the comb size corresponding to the first SL PRS are separately described above. It should be noted that configuration manners of the two parameters may be used in combination. For brevity, only five possible combinations are described below as an example.

In combination 1, the comb size corresponding to the first SL PRS is preconfigured, and the first frequency domain offset value is indicated by the network device.

For the comb size corresponding to the first SL PRS, the terminal device may determine it based on pre-configuration information of the SL PRS resource pool. That is, during pre-configuration of the SL PRS resource pool, an SL PRS comb size in a specified SL PRS resource pool may be configured.

For the first frequency domain offset value, the network device may send a configuration parameter to the terminal device to configure a first frequency domain offset.

In this embodiment of this application, the comb size is configured in the SL PRS resource pool in a preconfigured manner, which facilitates simplifying complexity of coordinating SL PRS resources between different terminal devices.

In combination 2, the comb size corresponding to the first SL PRS is preconfigured, and the first frequency domain offset value is autonomously selected by the terminal device.

For the comb size corresponding to the first SL PRS, the terminal device may determine it based on pre-configuration information of the SL PRS resource pool. That is, during pre-configuration of the SL PRS resource pool, an SL PRS comb size in a specified SL PRS resource pool may be configured.

For the first frequency domain offset value, the terminal device may select a first frequency domain offset based on a resource monitoring result.

In this embodiment of this application, the comb size is configured in the SL PRS resource pool in a preconfigured manner, which facilitates simplifying complexity of coordinating SL PRS resources between different terminal devices.

In combination 3, the comb size corresponding to the first SL PRS and the first frequency domain offset value are configured by the network device.

In some implementations, the terminal device may send first information to the network device, where the first information is used to indicate a comb size expected by the terminal device. Accordingly, the network device may determine, based on the comb size expected by the terminal device, the comb size corresponding to the first SL PRS and the first frequency domain offset value. Then, the network device may send a configuration parameter to the terminal device, where the configuration parameter includes the comb size corresponding to the first SL PRS and the first frequency domain offset value.

In some implementations, the terminal device may determine the expected comb size based on a positioning requirement.

In this embodiment of this application, the network device may configure, for the terminal device based on the comb size expected by the terminal device, the comb size corresponding to the first SL PRS, which helps meet positioning requirements of different terminal devices.

In combination 4, the comb size corresponding to the first SL PRS and the first frequency domain offset are autonomously determined by the terminal device.

For the comb size corresponding to the first SL PRS, the terminal device may select the comb size corresponding to the first SL PRS from the comb size set.

For the first frequency domain offset value, the terminal device may select a first frequency domain offset based on a resource monitoring result.

In combination 5, the comb size corresponding to the first SL PRS is autonomously determined by the terminal device, and the first frequency domain offset is configured by the network device.

For the comb size corresponding to the first SL PRS, the terminal device may select the comb size corresponding to the first SL PRS from the comb size set. In some implementations, the terminal device may send the comb size corresponding to the first SL PRS to the network device.

For the first frequency domain offset value, the network device may configure the first frequency domain offset value for the terminal device based on the comb size corresponding to the first SL PRS and selected by the terminal device.

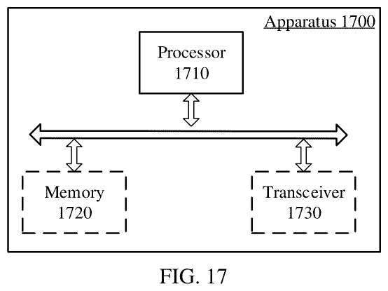

The method embodiments of this application are described in detail above with reference to FIG. 1 to FIG. 14. Apparatus embodiments of this application are described in detail below with reference to FIG. 15 and FIG. 17. It should be understood that the description of the method embodiments corresponds to the description of the apparatus embodiments, and therefore, for parts that are not described in detail, refer to the foregoing method embodiments.

FIG. 15 is a schematic diagram of a terminal device according to an embodiment of this application. A terminal device 1500 shown in FIG. 15 includes a processing unit 1510.

The processing unit 1510 is configured to determine a configuration parameter of a first sidelink positioning reference signal SL PRS, where the first SL PRS occupies a part or all of an SL PRS resource, and the configuration parameter is used to indicate one or more of the following information: a frequency domain resource, used for transmitting the first SL PRS, in the SL PRS resource; or an SL PRS sequence of the first SL PRS.

In a possible implementation, if the configuration parameter is used to indicate the frequency domain resource for the first SL PRS, the configuration parameter includes a first frequency domain offset value corresponding to a resource used for transmitting an SL PRS on a reference time domain unit of the SL PRS resource; and/or a comb size corresponding to the first SL PRS transmitted in the SL PRS resource.

In a possible implementation, if the configuration parameter includes the first frequency domain offset value, the reference time domain unit is an earliest time domain unit in time domain units included in the SL PRS resource.

In a possible implementation, the SL PRS resource further includes a first time domain unit used for transmitting the first SL PRS, and a frequency domain offset value corresponding to a resource used for transmitting the first SL PRS in the first time domain unit is determined based on the first frequency domain offset value and/or a first parameter, where the first parameter is used to indicate a quantity of time domain units between the reference time domain unit and the first time domain unit in the SL PRS resource, and/or a quantity of time domain units used for transmitting a PSSCH DMRS.

In a possible implementation, the SL PRS resource further includes a second time domain unit used for transmitting the first SL PRS, and a frequency domain offset value corresponding to a frequency domain resource of the first SL PRS in the second time domain unit is different from a frequency domain offset value corresponding to a resource used for transmitting a PSSCH DMRS in the SL PRS resource.

In a possible implementation, the second time domain unit is a 1^{st} time domain unit following a time domain unit used for transmitting a PSSCH DMRS in the SL PRS resource.

In a possible implementation, the configuration parameter is determined based on a resource monitoring result of the terminal device for the SL PRS resource.

In a possible implementation, if the configuration parameter is used to indicate the comb size corresponding to the first SL PRS, the comb size is used to indicate a frequency domain spacing between two adjacent SL PRSs transmitted by the terminal device in the SL PRS resource.

In a possible implementation, the frequency domain spacing is associated with a quantity of time domain units used for transmitting a PSSCH DMRS in the SL PRS resource.

In a possible implementation, if the SL PRS resource includes a time domain unit used for transmitting a PSSCH DMRS, the frequency domain spacing is two resource elements REs.

In a possible implementation, the comb size corresponding to the first SL PRS is less than or equal to a quantity of OFDM symbols used for sending an SL PRS in the SL PRS resource.

In a possible implementation, the configuration parameter belongs to a configuration parameter set, and the configuration parameter set includes a candidate value of one or more configuration parameters.

In a possible implementation, the candidate value in the configuration parameter set is associated with a resource pool type.

In a possible implementation, the comb size corresponding to the first SL PRS is determined based on an expected comb size of the terminal device.

In a possible implementation, the configuration parameter is determined by one or more of the following manners: selection by the terminal device, or configuration by a network device.

FIG. 16 is a schematic diagram of a network device according to an embodiment of this application. The network device 1600 shown in FIG. 16 includes a sending unit 1610.

The sending unit 1610 is configured to send a configuration parameter of a first sidelink positioning reference signal SL PRS to a terminal device, where the first SL PRS occupies a part or all of an SL PRS resource, and the configuration parameter is used to indicate one or more of the following information: a frequency domain resource, used for transmitting the first SL PRS, in the SL PRS resource; or an SL PRS sequence of the first SL PRS.

In a possible implementation, if the configuration parameter is used to indicate the frequency domain resource of the first SL PRS, the configuration parameter includes a first frequency domain offset value corresponding to a resource used for transmitting an SL PRS on a reference time domain unit of the SL PRS resource; and/or a comb size corresponding to the first SL PRS transmitted in the SL PRS resource.

In a possible implementation, if the configuration parameter includes the first frequency domain offset value, the reference time domain unit is an earliest time domain unit in time domain units included in the SL PRS resource.

In a possible implementation, the SL PRS resource further includes a first time domain unit used for transmitting the first SL PRS, and a frequency domain offset value corresponding to a resource used for transmitting the first SL PRS in the first time domain unit is determined based on the first frequency domain offset value and/or a first parameter, where the first parameter is used to indicate a quantity of time domain units between the reference time domain unit and the first time domain unit in the SL PRS resource, and/or a quantity of time domain units used for transmitting a PSSCH DMRS.

In a possible implementation, the SL PRS resource further includes a second time domain unit used for transmitting the first SL PRS, and a frequency domain offset value corresponding to a frequency domain resource of the first SL PRS in the second time domain unit is different from a frequency domain offset value corresponding to a resource used for transmitting a PSSCH DMRS in the SL PRS resource.

In a possible implementation, the second time domain unit is a 1^{st} time domain unit following a time domain unit used for transmitting a PSSCH DMRS in the SL PRS resource.

In a possible implementation, the configuration parameter is determined based on a resource monitoring result of the terminal device for the SL PRS resource.

In a possible implementation, if the configuration parameter is used to indicate the comb size corresponding to the first SL PRS, the comb size is used to indicate a frequency domain spacing between two adjacent SL PRSs transmitted by the terminal device in the SL PRS resource.

In a possible implementation, the frequency domain spacing is associated with a quantity of time domain units used for transmitting a PSSCH DMRS in the SL PRS resource.

In a possible implementation, if the SL PRS resource includes a time domain unit used for transmitting a PSSCH DMRS, the frequency domain spacing is two REs.

In a possible implementation, the comb size corresponding to the first SL PRS is less than or equal to a quantity of OFDM symbols used for sending an SL PRS in the SL PRS resource.

In a possible implementation, the configuration parameter belongs to a configuration parameter set, and the configuration parameter set includes a candidate value of one or more configuration parameters.

In a possible implementation, the candidate value in the configuration parameter set is associated with a resource pool type.

In a possible implementation, the comb size corresponding to the first SL PRS is determined based on an expected comb size of the terminal device.

In a possible implementation, the network device is an access network device or a core network device.

In an optional embodiment, the processing unit 1510 may be a processor 1710. The terminal device 1500 may further include a transceiver 1730 and a memory 1720. Details are shown in FIG. 17.

In an optional embodiment, the sending unit 1610 may be a transceiver 1740. The network device 1600 may further include a transceiver 1730 and a memory 1720. Details are shown in FIG. 17.

FIG. 17 is a schematic diagram of a structure of a communication apparatus according to an embodiment of this application. Dashed lines in FIG. 17 indicate that the unit or module is optional. The apparatus 1700 may be configured to implement the methods described in the foregoing method embodiments. The apparatus 1700 may be a chip, a terminal device, or a network device.

The apparatus 1700 may include one or more processors 1710. The processor 1710 may allow the apparatus 1700 to implement the methods described in the foregoing method embodiments. The processor 1710 may be a general-purpose processor or a dedicated processor. For example, the processor may be a central processing unit (CPU). Alternatively, the processor may be another general-purpose processor, a digital signal processor (digital signal processor, DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1700 may further include one or more memories 1720. The memory 1720 stores a program. The program may be executed by the processor 1710, to cause the processor 1710 to perform the methods described in the foregoing method embodiments. The memory 1720 may be separated from or integrated into the processor 1710.

The apparatus 1700 may further include a transceiver 1730. The processor 1710 may communicate with another device or chip through the transceiver 1730. For example, the processor 1710 may transmit data to and receive data from another device or chip through the transceiver 1730.

An embodiment of this application further provides a computer-readable storage medium, configured to store a program. The computer-readable storage medium may be applied to a terminal or a network device provided in embodiments of this application, and the program causes a computer to perform the methods to be executed by the terminal or the network device in various embodiments of this application.

An embodiment of this application further provides a computer program product. The computer program product includes a program. The computer program product may be applied to the terminal or the network device provided in embodiments of this application, and the program causes a computer to perform the methods performed by the terminal or the network device in various embodiments of this application.

An embodiment of this application further provides a computer program. The computer program may be applied to the terminal or the network device provided in embodiments of this application, and the computer program causes a computer to perform the methods performed by the terminal or the network device in various embodiments of this application.

It should be understood that the terms “system” and “network” in this application may be used interchangeably. In addition, the terms used in this application are merely used to explain the specific embodiments of this application, and are not intended to limit this application. The terms “first”, “second”, “third”, “fourth”, and the like in the specification, claims, and accompanying drawings of this application are intended to distinguish different objects from each other, rather than defining a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association between two elements, or that there is an association relationship of “indicating” and “being indicated”, “configuring” and “being configured”, or the like.

In embodiments of this application, “pre-definition” or “pre-configuration” can be implemented by prestoring corresponding code or a corresponding table in a device (for example, including a terminal device and a network device) or in other manners that can be used for indicating related information. A specific implementation thereof is not limited in this application. For example, predefining may indicate being defined in a protocol.

In embodiments of this application, the “protocol” may indicate a standard protocol in the communications field, which may include, for example, an LTE protocol, an NR protocol, and a related protocol applied to a future communication system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate components may be or may not be physically separate, and the components displayed as units may be or may not be physical units, and may be at one place, or may be distributed on a plurality of network units. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented through software, hardware, firmware, or any combination thereof. When the software is used to implement embodiments, all or some of embodiments may be implemented in the form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A sidelink positioning method, comprising:
determining, by a terminal device, a configuration parameter of a first sidelink positioning reference signal (SL PRS), wherein the first SL PRS occupies a part or all of an SL PRS resource;
wherein the configuration parameter is used to indicate one or more of following information:
a frequency domain resource, used for transmitting the first SL PRS, in the SL PRS resource; or
an SL PRS sequence of the first SL PRS.

2. The method according to claim 1, wherein if the configuration parameter is used to indicate the frequency domain resource for the first SL PRS, the configuration parameter comprises a first frequency domain offset value corresponding to a resource used for transmitting an SL PRS on a reference time domain unit of the SL PRS resource; and/or
a comb size corresponding to the first SL PRS transmitted in the SL PRS resource.

3. The method according to claim 2, wherein if the configuration parameter comprises the first frequency domain offset value, the reference time domain unit is an earliest time domain unit in time domain units comprised in the SL PRS resource.

4. The method according to claim 2, wherein the SL PRS resource further comprises a first time domain unit used for transmitting the first SL PRS, and a frequency domain offset value corresponding to a resource used for transmitting the first SL PRS in the first time domain unit is determined based on the first frequency domain offset value and/or a first parameter, wherein the first parameter is used to indicate a quantity of time domain units between the reference time domain unit and the first time domain unit in the SL PRS resource.

5. The method according to claim 2, wherein if the configuration parameter is used to indicate the comb size corresponding to the first SL PRS, the comb size is used to indicate a frequency domain spacing between two adjacent SL PRSs transmitted by the terminal device in the SL PRS resource.

6. The method according to claim 5, wherein the configuration parameter belongs to a configuration parameter set, and the configuration parameter set comprises a candidate value of one or more configuration parameters.

7. The method according to claim 1, wherein the configuration parameter is used to indicate a comb size corresponding to the first SL PRS, and the comb size is determined by one or more of following manners: selection from a configuration parameter set by the terminal device, or indication from the configuration parameter set by a network device.

8. A sidelink positioning method, comprising:
sending, by a network device, a configuration parameter of a first sidelink positioning reference signal (SL PRS) to a terminal device, wherein the first SL PRS occupies a part or all of an SL PRS resource;
wherein the configuration parameter is used to indicate one or more of following information:
a frequency domain resource, used for transmitting the first SL PRS, in the SL PRS resource; or
an SL PRS sequence of the first SL PRS.

9. The method according to claim 8, wherein if the configuration parameter is used to indicate the frequency domain resource for the first SL PRS, the configuration parameter comprises a first frequency domain offset value corresponding to a resource used for transmitting an SL PRS on a reference time domain unit of the SL PRS resource; and/or
a comb size corresponding to the first SL PRS transmitted in the SL PRS resource.

10. The method according to claim 9, wherein if the configuration parameter comprises the first frequency domain offset value, the reference time domain unit is an earliest time domain unit in time domain units comprised in the SL PRS resource.

11. The method according to claim 9, wherein the SL PRS resource further comprises a first time domain unit used for transmitting the first SL PRS, and a frequency domain offset value corresponding to a resource used for transmitting the first SL PRS in the first time domain unit is determined based on the first frequency domain offset value and/or a first parameter, wherein the first parameter is used to indicate a quantity of time domain units between the reference time domain unit and the first time domain unit in the SL PRS resource.

12. The method according to claim 9, wherein if the configuration parameter is used to indicate the comb size corresponding to the first SL PRS, the comb size is used to indicate a frequency domain spacing between two adjacent SL PRSs transmitted by the terminal device in the SL PRS resource.

13. The method according to claim 12, wherein the configuration parameter belongs to a configuration parameter set, and the configuration parameter set comprises a candidate value of one or more configuration parameters.

14. The method according to claim 9, wherein the network device is an access network device or a core network device.

15. A terminal device, comprising:
a processor and a memory, wherein the memory is configured to store a computer program, and the processor is configured to invoke and run the computer program stored in the memory to cause the first device to perform:
determining, a configuration parameter of a first sidelink positioning reference signal (SL PRS), wherein the first SL PRS occupies a part or all of an SL PRS resource, and the configuration parameter is used to indicate one or more of following information:
a frequency domain resource, used for transmitting the first SL PRS, in the SL PRS resource; or
an SL PRS sequence of the first SL PRS.

16. The terminal device according to claim 15, wherein if the configuration parameter is used to indicate the frequency domain resource for the first SL PRS, the configuration parameter comprises a first frequency domain offset value corresponding to a resource used for transmitting an SL PRS on a reference time domain unit of the SL PRS resource; and/or
a comb size corresponding to the first SL PRS transmitted in the SL PRS resource.

17. The terminal device according to claim 16, wherein if the configuration parameter comprises the first frequency domain offset value, the reference time domain unit is an earliest time domain unit in time domain units comprised in the SL PRS resource.

18. The terminal device according to claim 16, wherein the SL PRS resource further comprises a first time domain unit used for transmitting the first SL PRS, and a frequency domain offset value corresponding to a resource used for transmitting the first SL PRS in the first time domain unit is determined based on the first frequency domain offset value and/or a first parameter, wherein the first parameter is used to indicate a quantity of time domain units between the reference time domain unit and the first time domain unit in the SL PRS resource.

19. The terminal device according to claim 16, wherein if the configuration parameter is used to indicate the comb size corresponding to the first SL PRS, the comb size is used to indicate a frequency domain spacing between two adjacent SL PRSs transmitted by the terminal device in the SL PRS resource.

20. A network device, comprising a transceiver, a memory, and a processor, wherein the memory is configured to store a program, and the processor is configured to invoke the program in the memory and control the transceiver to send and receive a signal, to cause the network device to perform the method according to claim 8.
